(19) United States
(12) Patent Application Publication
(10) Pub. No.: US 2017/0069142 A1
(43) Pub. Date: Mar. 9, 2017

(54) GENIE SURFACE MATCHING PROCESS

(71) Applicant: David Elmekies, Brooklyn, NY (US)

(72) Inventor: David Elmekies, Brooklyn, NY (US)

(21) Appl. No.: 15/357,504

(22) Filed: Nov. 21, 2016

Related U.S. Application Data
(63) Continuation-in-part of application No. 14/514,685, filed on Oct. 15, 2014.
Application No. 14/514,685 is a continuation-in-part of application No. 14/808,715, filed on Jul. 24, 2015.
Application No. 14/808,715 is a continuation of application No. 13/345,069, filed on Jan. 6, 2012, now Pat. No. 9,092,061.
(60) Provisional application No. 61/890,989, filed on Oct. 15, 2013.
(60) Provisional application No. 61/430,319, filed on Jan. 6, 2011.

(51) Int. Cl. G06T 19/00; G06T 7/00; G06Q 30/06; G06K 9/62; G06F 3/00; G06T 19/20; G06F 3/01; G06K 9/46

(52) U.S. Cl. CPC G06T 19/006; G06F 3/011; G06T 7/0085; G06K 9/4604; G06K 9/6202; G06F 3/005; G06T 19/20; G06Q 30/0643; G06T 2200/04; G06T 2207/20192; G06T 2219/2004; G06T 2210/04

(57) ABSTRACT

The present invention is directed to a device, a system, and methods, in which a representation of a room, with existing furnishings and accessories, can be displayed, where the display is automatically adjustable based upon images obtained by a camera in or associated with the device. In addition, the display can be augmented by insertions of content by a user, such as content representing further furnishings. The user can select the positioning of the further furnishings relative to the room. As the user scans a room with the camera, the orientation of the room and furnishings is automatically adjusted.

The present invention claims priority to and is a continuation in part of U.S. patent application Ser. No. 14/514,685, filed Oct. 15, 2014 now pending and incorporated by reference, which claims priority from U.S. Provisional Patent Application No. 61/890,989, filed on Oct. 15, 2013. The present invention also claims priority to and is a continuation in part of U.S. patent application Ser. No. 14/808,715, filed Jul. 24, 2015 now pending and incorporated by reference, which is a continuation of and claims priority to U.S. patent application Ser. No. 13/345,069, filed on Jan. 6, 2012 and issued on Jul. 28, 2015 as U.S. Pat. No. 9,092,061, which claims priority to U.S. Provisional Patent Application No. 61/430,319, filed on Jan. 6, 2011.

### BRIEF DESCRIPTION OF THE PRESENT INVENTION

The present invention builds on the aforementioned applications, incorporated by reference, by introducing specifics relative to display of a virtual room with introduction of objects in the room.

### BRIEF DESCRIPTION OF THE FIGURES

FIG. 1 depicts an example digital photograph may be a snap shot of a room.

FIG. 2 depicts a display of a Virtual Room indicating the position of the surfaces in a photograph and showing, in solid lines, the edges of those surfaces.

FIG. 3a depicts the position and orientation of a virtual camera within a virtual room as seen from above. The resultant projection is overlaid on top of the target photograph in the bottom right corner.

FIG. 3b depicts the same elements as in FIG. 3a after the camera has been through a camera yaw transformation. The result is the camera oriented towards the “back” wall. The resultant projection of the virtual room is overlaid on top of the input photograph in the bottom right corner.

### DETAILED DESCRIPTION OF THE PRESENT INVENTION

The present invention is directed to a device, a system, and methods, in which a representation of a room or a virtual representation of the room, with existing and potential furnishings and accessories, can be displayed, where the display is automatically adjustable based upon images obtained by a camera in or associated with the device. In addition, the display can be augmented by insertions of content by a user, such as content representing further furnishings. The user can select the positioning of the further furnishings relative to the room. As the user scans a room with the camera, the orientation of the room and existing and potential (further) furnishings is automatically adjusted in the display.

The system and methods of the present invention can be applied to a variety of needs, such as but not limited to interior and/or exterior design work. In one example, a user can use the approach of the present invention to “try out” different furnishings or wall/floor coverings in a virtual way before purchasing the best fit/best match furnishings.

A goal of this process is to accurately replicate an entire room or a portion of a room by using a photograph and/or video, such as but not limited to a live video, and deterministically extracting one or more of the walls, floor, and ceiling surfaces, perhaps in combination, so as to create a virtual three dimensional (3D) version of the room complete with dimensions and existing content, adding furnishings as may be desired, and then matching those surfaces or areas with virtual surfaces that can be textured to accurately reflect the position, orientation and relative (and potentially actual) scale of the surfaces.

A further goal is to use the representation by allowing a user to insert other objects into the representation, such as changing a wall color, adding a painting, or adding furnishing, accessories, or flooring, so as to permit a user to visualize the room with the potential changes and content, such as would be useful as a part of a purchase decision.

A further goal is to achieve the earlier goals in various orientations. In particular, as a user might aim a camera, or change the camera's orientation or zoom, the display of the room with its potential changes and content would be automatically adjusted. Such an approach allows a user, in effect, to potentially see the potentially equipped room from a plurality or positions and orientations.

When designing the layout of a room or a space, it is important to have the ability to observe the room from a plethora of orientations, either in actuality or virtually. Virtual observation has significant benefit over actual observation. For example, one can see what the room looks like with various wall coverings or paint colors, without the need to paint the room or install the coverings. To create this virtual representation, particularly where the representation can give the observer, in effect, a 3D representation, the present invention may use a picture, a plurality of pictures, or a series of frames from a video to form a virtual version of the room visible on a computing device. These pictures or video may be taken from a camera or storage device in control of a user or may be a priori stored in a data store and uploaded for present use (such as when the user is not near the room). In one embodiment, multiple photographs and/or frames are taken as a group, commonalities are identified, and the images are assembled to aid in replicating the entirety or a portion of a room in three dimensions. To facilitate such a 3D representation some combination of metadata indicative of the pitch, roll, yaw, height, and distance from walls of the camera at the time each photograph or frame is taken are gathered together with the photographs or frames themselves. The images can be pasted together (in a virtual sense) algorithmically to formulate a 3D representation of the room or space of interest. These metadata regarding camera positioning and orientation in the room may be available from the device encompassing the camera or may be deterministically captured based on content of the photograph or frame.

The implementation takes as input a digital image and, optionally, some combination of the pitch/roll/yaw of the camera that produces the image (e.g., camera orientation and potentially height), and determines the correct position, scale and orientation of a set of virtual surfaces relative to the proper orientation and position of a virtual camera. Potentially, a sensor (or a series of sensors) can be used so as to detect distances from the camera. Such data can be a part of the metadata discussed in this application. This technique is cross platform, and can be performed on PCs, mobile devices, or remote servers using an image (or video) of a camera concurrently with location and orientation parameters of the camera at the time of the image or video.

An example is described below.

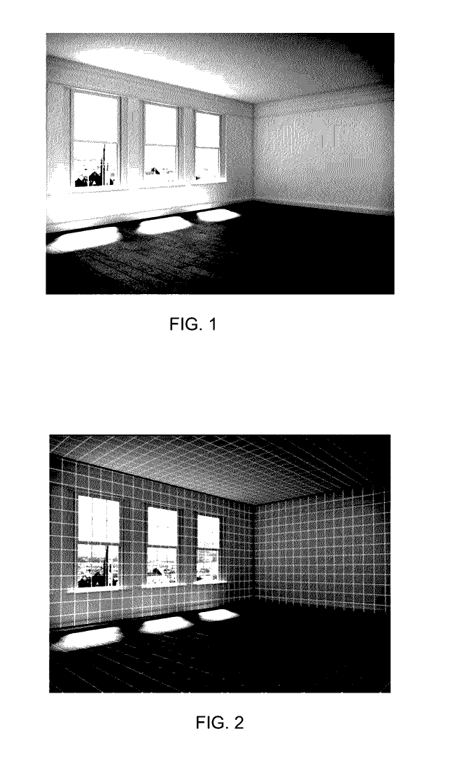

First one or more digital photographs may be taken and input to the system of the present invention. The digital photograph may be a snap shot of a room, one frame of a video of the room, or a digitized film photograph of the room. See FIG. 1 as an example.

As shown in the example depicted in FIG. 1, the photograph is preferably of a portion of a (or a complete) room. In this particular case, the room is barren of furnishings and only includes finished walls and flooring, such as might be available at the time of move in. In another scenario the room could be at least partially furnished. In this example, a goal of the present invention is to recognize relative positions of surfaces and items which may be embedded in surfaces, such as windows and molding.

The digital photograph may remain resident on the device inclusive of the camera or may be uploaded to a server and later manipulations of the image in the photograph may be performed at either locale or in combination.

The system of the present invention accepts the photographic input and, as detailed below, analyzes the image(s) to determine and identify walls, ceiling, and floors, together with locations of other items, such as windows, all relative to one another. Based on analysis, such as including data indicating distances at the time of shooting photographs, the system of the present invention understands relative distances and dimensions of the room. Based on analysis, the system of the present invention modifies the image in a series of successive ways. Initially, the present invention requires determining and recognizing boundaries between walls, floor, and ceiling. The present invention initially constructs a Virtual Room (see FIG. 2) indicating the position of the surfaces in the photograph and determines and shows, in solid lines, the edges of those surfaces. The grid is beneficial to a user in later determining placement of objects as the grid separations are of defined distance in the actual room. The grid lines are adjustable to indicate a defined distance, e.g., grid lines can be placed so as to represent one foot (or some other distance) separation. The relative positioning of the virtual room and the display of a virtual camera is a goal. Once this is done, it becomes possible for a user to “place” objects, or painting surfaces in the correct perspective. That is, a user can select a representation of an object, such as a chair, from a data store of such representations and have it selectively placed in the virtual room. The representation of the chair or other object can have three dimensional attributes—that is, the representation can be a series of images or images plus metadata, so that the system of the present invention can change the orientation or appearance of the object depending upon the orientation of the room in a display.

Edge/Boundary Determination.

The present invention processes an image to determine a change in orientation, such as by recognizing a change, not limited to color variation, a seam, or some other change. In addition, because the image processing recognizes a change in orientation within the image and determines that change in orientation to be an edge, the grid on the screen may widen or narrow, but in the “real” room, the grid lines would be equally separated.

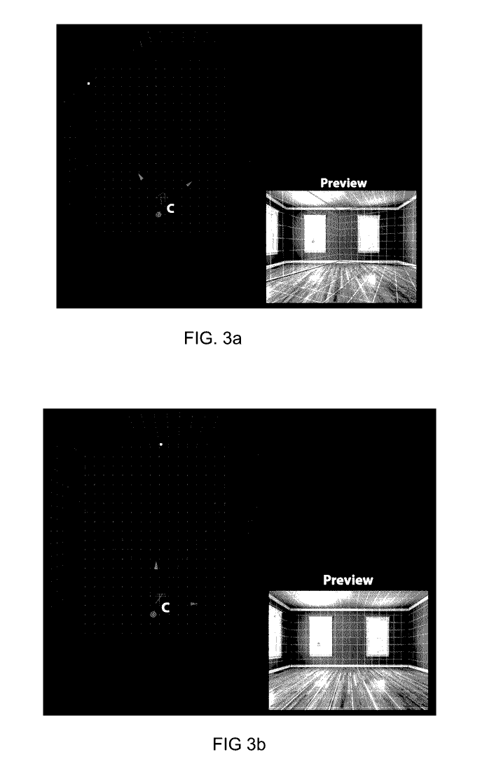

It is initially important to determine boundaries, or edges, between different surfaces. There are 6 distinct stages to the process of edge identification and presentation. These are, in order: Edge Extraction; Edge Merging; Edge Categorization; Seam Rationalization; Match Strategy Determination; Iterative Matching.
1. Edge Extraction. In the Edge Extraction stage, the image is run through a series of filters (down scaling, blurring, histogram equalization, brightness/contrast enhancement, and posterization). The image is then run through a Canny or Canny-like filter to detect some or all edges. That is, an algorithm inclusive of a calculus of variations is used, such as but not limited to identifying a first derivative of a Gaussian distribution. The algorithm then progresses to include use of a Hough filter (or equivalent) to extract straight line segments from the Canny-identified edges. The result of this stage is zero or more line segments (which are understood to be at least portions of edges). Each line segment has a determinable length and slope.
2. Edge Merging: In the Edge Merging stage, line segments (Edges) that have been extracted from the image are compared and, if their end points and slopes are suitably close and/or have commonality, are merged to form longer segments.
3. Edge Categorization: In this stage, the merged edges are now each ranked as likely candidates for a seam between two surfaces in the target virtual room. The “target virtual space” is our assumed arrangement of walls and ceiling, e.g., in our current implementation, we start with a simple virtual box, the interiors of which represent the walls, floor and ceiling of an idealized room. So, in the ranking stage described here we determine the likelihood, e.g., that a given edge is the seam between the ceiling and the back wall. We do this by giving each edge a “score” that represents the likelihood that it is a given seam (i.e., back-wall/ceiling, back-wall/left-wall, etc.). Every edge is given a score based on a series of rules. For instance, one rule might say that edges that are recognized as being lower down in the room are more likely to be floor/wall seams than ceiling/wall seams. The system supports an indefinite number of rules, organized into “sets” of rules which produce a score for each known seam in the target virtual space. For example, there might be 10 rules which produce a score for the floor/back-wall seam. Every rule set is applied to every edge, and for each rule set, the highest scoring edge is selected as a possible candidate for that seam. That is, if there are 30 edges, and 6 possible target seams, the system will produce 180 “scores” and the best scoring edge for each of the 6 targets will be chosen as the best possible representative for that target seam, and so on. The result of this stage is a set of identified seams. In the present invention, a processor is programmed to implement these rules.
4. Seam Rationalization: A seam set is defined as a series of seams which together form the boundaries of one or more surfaces in the virtual room. A goal of this stage is to formulate a collection of seams which together form the boundaries of as many surfaces as possible. In this stage, the best (and in some cases second or third best) seams are grouped into “rational Seam Sets”. A rational seam set is one that “makes sense” given the known relationship of the surfaces in the virtual room and (optionally) known orientation of the physical camera that produced the input image. “Known” means known from the target virtual space, e.g. the system will consider it less “rational” that a photograph would contain a seam between a left-wall/floor AND a seam between the right-wall/floor that intersects it. In that case, we would re-categorize one of those two as being the back-wall/floor seam in order to make the set (of two in this case) make sense. For example, a set of seams representing a left/back wall, the left/floor, and the back/floor would be consider a more “rational” choice than a set representing the back/left and right/left walls since such a combination is more likely to produce a better match. In this stage, some seams may be re-categorized, or lower scoring seams may be promoted due to their role in producing the most “rational” set. The result of this stage is a determination of seams, which might differ from previous determinations.
5. Match Strategy Determination: In this stage, the system determines the best order and type of virtual camera transformations (such as pitch, roll, and yaw) and surface transformations to perform in order to most closely match the target seam set determined in step 4. Operations are 3D matrix transformations, performed iteratively, e.g., a “Camera Yaw” operation which would turn the virtual camera to match a virtual seam against a potential target seam extracted from the image (see FIGS. 3a and 3b below).
6. Iterative Matching: In the final stage, match operations are performed. Matches are performed iteratively, meaning each individual operation step previously determined by the Match Strategy Determination stage is repeated until a suitable termination condition is met. For example, a “surface push to intersect” operation would transform the position of a surface relative to other virtual surfaces until one of the seams of the virtual surface intersected the target seam that had been extracted from the original image. Step 6 can be performed with or without visual feedback to the user.

FIG. 3a: Shows the position and orientation of the virtual camera within the virtual room as seen from above. The camera is pointing at the corner of the virtual room. The resultant projection is overlaid on top of the target photograph in the bottom right corner.

FIG. 3b: Shows the same elements after the camera has been through a Camera Yaw transformation. The result is the camera oriented towards the “back” wall. The resultant projection of the virtual room is overlaid on top of the input photograph in the bottom right corner.

Once Step 6 is completed, the result is both a modified virtual space and a score, indicating the confidence the system has in the match it produced. This virtual space can then be textured in order to visualize, for instance, how a new surface treatment would look on walls of the photograph. Similarly, virtual 3D objects can be placed in the space, and appear properly synchronized in scale and position to the original input photograph.

Technique for Rendering Augmented Reality Textures and Objects Within a Photograph or Live Video Feed

Once the edges are identified, the room can be characterized, including characterizing the dimensions, the locations of existing objects, and any deformities that may exist in the room. If there are objects present in the room or within the surface, such as a window frame or a couch, the dimensions and locations of the objects are recognized in a manner similar to how the room edges are identified. Because objects which are delivered to the display are a consequence of having been photographed, once placed in the image of the virtual room, any shape or pattern with the object flows with the object.

Once the room is characterized (that is, a “virtual” room is understood to exist with particular dimensions), items such as furnishings, flooring, paint, and so on can be placed in the virtual room. The present invention uses a photo or video feed to create a virtual 3D room made up of wall, floor and ceiling surfaces. These surfaces are “matched” to the photo/video input (see above) for assurance of consistency. Once matched, they are kept at least positionally synchronized (in a video feed) by monitoring and updating feature changes and device position. That is, in the context of the present invention, a user can use a mobile device, such as but not limited to a smart phone a tablet, or a computer, where the device includes a video camera, to take on-going video of the room and the present invention applies the known boundaries to the video, thereby creating a real time 3D virtual recreation of the actual room, complete with dimensional knowledge. In one embodiment, as the user uses a camera, such as one on a mobile smart phone, to scan a room, the actual view of the room is replaced with the virtual room, potentially inclusive of grid lines and edges as shown in FIG. 2, and as the user scans the room, the image appearing on the screen is delivered in synch with the movement of the camera. In another embodiment, the movement of the device may result in positional/orientation adjustment of the display, even if the covering of the device is not directed toward the room as shown in the display.

In the context of the present invention, a database exists encompassing representations of furnishings and other physical objects, including their color(s), dimensions, and photographic (or otherwise created) images of the furnishings and other physical objects for placement in the virtual room, such that a viewer such as a home owner can see a representation of their room with the selected furniture. The database (or a corresponding database) also encompasses representations of colors and options usable to change existing color and pattern schemes, such as but not limited to wall coverings, floor coverings, and furniture patterns. In addition, the database also includes representations of two dimensional elements that could be included in the room, such as but not limited to paint, flooring, tile, etc. These representations also include color(s) and photographic (or otherwise created) images. In the context of the present invention, should a user select one or more of these two dimensional representations, the system of the present invention can determine the dimensions needed and size a purchase of the materials.

In one embodiment, as the user uses a camera, such as one on a mobile smart phone, to scan a room, the actual view of the room is replaced with the virtual room, potentially inclusive of grid lines and edges as shown in FIG. 2, as well as furnishings and coverings, and as the user scans the room, the image appearing on the screen is delivered in synch with the movement of the camera.

We utilize a proprietary technique and a set of algorithms for rendering room surfaces and objects within a virtual room in accurate position and scale as compared to a still photo or video feed.

The technique renders 3D models and textures and keeps them in the correct orientation/scale to the room by keeping a virtual camera in the same position as the actual camera through which the physical scene has been captured. The Field of View (FOV) of the camera is also matched, to ensure that the perspective of surface details (tiles, wallpaper, pictures, etc.) is accurate.

Content Management System (CMS) Design to Support Very Large Data Sets of Physical Objects and Surface Treatments and Supply Them to Client Applications

The CMS design supports importing, storing, modifying and providing to end users an indefinitely large set of objects and surface treatments for use in visualizing augmented spaces.

The key components/processes in the system are:
1. Data Model: A model that includes both an intermediate model for translation of source data into system data, and a flexible system data model that supports a wide range of furniture, object and surface treatment models. The data model utilizes both the obtained image/video, the processed version of the obtained image/video (the virtual room), and the content of the database encompassing representations of objects and surfaces.
2. An Asynchronous Data Import Process: A system and its implementation supporting importing source data from any of several formats into an intermediate format which can be validated pre-insertion and into a final format for use in client applications. That is, the process takes potentially arbitrarily formatted content (such as related to furnishings or surfaces), converts the content to a usable format for insertion, stores the converted content in the database of the present invention, and moves content on demand into the created virtual room for display.

Data Model: The data model defines both an intermediate format (for temporary storage and validation) and a final normalized model for any physical object or surface treatment. The intermediate format defines the common features of all objects and is extensible. It provides suitable visibility for pre-import validation of metadata and media, which increases the speed and robustness of the system overall.

Asynchronous Data Import Process: The import process defines the objects and algorithms suitable for the translation of an arbitrary source format to an intermediate format for validation and final import into the CMS. It divides the import process into 4 steps:
Initial Import: In this step, data is supplied to the system via one or more data files or URLs. Data is broken up into separate raw packages per object for later processing and asynchronous jobs are started for per object processing. This allows for processing to be spread across multiple processes on multiple virtual or physical devices.
Parsing: In the parsing step, each data package is processed to translate the arbitrary source format into the intermediate format. Initial validation is performed to ensure required fields are present. This process is performed asynchronously, utilizing as many worker processes as desired to complete the job quickly.
Validation: In the validation step, intermediate data packages are validated to ensure source media is present and suitable, and metadata is within user specified ranges.
Final Import: In the final import stage, the validated packages are imported and saved in the normalized model form in a database, to allow for efficient retrieval by clients.

Collaborative Design Evaluation/Voting System for Interior/Architectural Design.

The present system includes allowing end users to share multiple views of a design project with known or anonymous collaborators. Collaborators are given a simple voting interface which supports both a numeric and binary voting system. The system stores collaborator votes, then tabulates these and weights them, using criteria which may include being based on previous collaborator contributions. The results evaluation is presented to the original designer, along with a mechanism for them to see specific collaborators raw and weighted votes.

1. A method for a hand-held processing device with access to at least one data store to display a virtual presentation of a room together with overlaid content, displayable in real time on said hand-held processing device incorporating a display, comprising the steps of:
forming a virtual 3D representation of a room, said formulation based on a plurality of photographic images of said room;
processing said plurality of photographic images so as to identify room contents and room and content edges, as well as their positions and orientations;
overlaying a digitized image of an object on said virtual representation, said overlaid image received from a data store of digitized images, said digitized image sized and oriented based on the actual size of said object; and
displaying said representation with said overlaid image on said device;
wherein the display of said overlaid image and said virtual representation is automatically reoriented based on movement of said hand-held processing device and said overlaid image may be representative of objects which could be placed in said room.

2. The method of claim 1, wherein said overlaid images are chosen for display by a user.

3. The method of claim 1, wherein said display depicts a portion and orientation of a room aligned with the orientation of a camera on said device.

4. The method of claim 1, wherein said display includes grid lines, said grid lines spaced to indicate at least one defined distance.

5. The method of claim 1, wherein said plurality of photographic images are sourced from a plurality of photographs.

6. The method of claim 1, wherein said plurality of photographic images are sourced from video.

7. The method of claim 1, wherein said virtual representation is prepared using the steps of edge extraction, edge merging, edge categorization, seam rationalization, match strategy determination, and iterative matching.

8. The method of claim 7, wherein said preparation results in identification of edges based on a set of rules, said rules implemented through a programmed processor.

9. The method of claim 1, wherein a user has control of an object placed in said display, can reposition said object in said display, and a representation of said object becomes re-oriented as said representation is moved within said display based on orientation of said room in said display.

10. The method of claim 1, wherein a user has control to change a wall, ceiling, or floor surface in said display, and said surface is adjusted based on orientation and position of said wall, ceiling, or floor.

11. A device for displaying a virtual presentation of a room together with potential content, displayable in real time on said hand-held processing device incorporating a display comprising
a processor;
a video camera; and
a communications port for access to at least one data;
wherein said processor is programmed to:
form a virtual 3D representation of a room, said formulation based on a plurality of photographic images of said room;
process said plurality of photographic images so as to identify room contents and room and content edges, as well as their positions and orientations;
overlay a digitized image of an object on said virtual representation, said overlaid image received from a data store of digitized images, said digitized image sized and oriented based on the actual size of said object;
display said representation with said overlaid image on said device; and
automatically reoriented the display of said overlaid image and said virtual representation based on movement of said hand-held processing device;
wherein said overlaid image may be representative of objects which could be placed in said room

12. The device of claim 11, wherein said overlaid images are chosen for display by a user.

13. The device of claim 11, wherein said display depicts a portion and orientation of a room aligned with the orientation of a camera on said device.

14. The device of claim 11, wherein said display includes grid lines, said grid lines spaced to indicate at least one defined distance.

15. The device of claim 11, wherein said plurality of photographic images are sourced from a plurality of photographs.

16. The device of claim 11, wherein said plurality of photographic images are sourced from video.

17. The device of claim 11, wherein said virtual representation is prepared using the steps of edge extraction, edge merging, edge categorization, seam rationalization, match strategy determination, and iterative matching.

18. The device of claim 11, wherein said preparation results in identification of edges based on a set of rules, said rules implemented through a programmed processor.

19. The device of claim 11, wherein a user has control of an object placed in said display, can reposition it in said display, and said object becomes re-oriented as it is moved within said display based on orientation of said room in said display.

20. The device of claim 11, wherein a user has control to change a wall, ceiling, or floor surface in said display, and said surface is adjusted based on orientation and position of said wall, ceiling, or floor.
